(19) United States
(12) Patent Application Publication
(10) Pub. No.: US 2015/0224026 A1
(43) Pub. Date: Aug. 13, 2015

(54) CHILD-RESISTANT BLISTER CARD CASE

(71) Applicant: Berry Plastics Corporation, Evansville, IN (US)

(72) Inventors: Ryan P Davidson, Evansville, IN (US); Steven Gift, Lititz, PA (US)

(21) Appl. No.: 14/618,300

(22) Filed: Feb. 10, 2015

Related U.S. Application Data
(60) Provisional application No. 61/938,421, filed on Feb. 11, 2014.

(51) Int. Cl. A61J 1/03; B65D 50/00; B65D 43/26; B65D 43/16; B65D 43/22

(52) U.S. Cl. CPC A61J 1/035; B65D 43/16; B65D 43/22; B65D 43/26; B65D 50/00

(57) ABSTRACT

A package includes a child-resistant case and blister cards. The child-resistant case includes a lid that can be opened to access the blister cards.

### PRIORITY CLAIM

This application claims priority under 35 U.S.C. §119(e) to U.S. Provisional Application Ser. No. 61/938,421, filed Feb. 11, 2014, which is expressly incorporated by reference herein.

### BACKGROUND

The present disclosure relates to child-resistant packaging for medicines such as tablets and for other articles, and particularly to packaging for tablet-carriers. More particularly, the present disclosure relates to containers for storing tablet-carrying blister cards.

### SUMMARY

A package in accordance with the present disclosure includes a case comprising a base and a lid coupled to the base. In illustrative embodiments, the package also includes a tablet carrier mounted for movement relative to the case. The tablet carrier is configured to carry tablets or other items on a movable sheet. In illustrative embodiments, the tablet carrier is a tablet-carrying blister card.

In illustrative embodiments, the package includes a child-resistant case and a set of tablet-carrying blister cards. The blister cards are configured to be mounted in stored positions inside the child-resistant case and accessed by an authorized user only when the child-resistant case is unlocked and opened.

In illustrative embodiments, the child-resistant case includes a base formed to include an interior card-storage region and a pivotable card-access lid including a lid shell that is coupled to a first end of the base for pivotable movement about a lid pivot axis by a lid hinge. The child-resistant case also includes a slidable lid retainer mounted for slidable movement on an opposite second end of the base relative to the pivotable card-access lid to control pivoting of the lid relative to the base from a closed position to an opened position.

When unlocked, the lid retainer is slidable on the base between (1) a lid-motion-blocking position arranged to block pivotable movement of the card-access lid about a lid pivot axis from a closed position to an opened position and (2) a lid-motion-permitting position arranged to free the card-access lid so that it can be pivoted by a user about the lid pivot axis from the closed position to the opened position to allow the user to access blister cards stored in the interior card-storage region formed in the base. In illustrative embodiments, the lid retainer is configured to slide in a direction away from the lid pivot axis during sliding movement of the lid retainer on the second end of the base from the lid-motion-blocking position toward the lid-motion-permitting position.

In illustrative embodiments, the child-resistant case also includes a first lid lock associated with the base and the slidable lid retainer. The first lid lock is configured to provide means for locking the slidable lid retainer in a stationary position on the base to trap a free end of the lid in a stationary position between the slidable lid retainer and the base to retain the lid in the closed position on the base. The first lid lock provides means for locking a spring-biased first latch coupled to a first side of the base body. The spring-biased first latch is urged by an elastic latch-return spring to engage a first keeper coupled to the slidable lid retainer when the slidable lid retainer has been moved to the lid-motion-blocking position so that the pivotable card-access lid is retained in the closed position on the base. In illustrative embodiments, the child-resistant case also includes a second lid lock comprising a spring-biased second latch coupled to an opposite second side of the base body.

To actuate the first lid lock in accordance with the present disclosure, a user manually applies a push force to push the spring-biased first latch inwardly toward the blister cards located in the interior card-storage region of the base to cause the first latch to disengage the first keeper coupled to the slidable lid retainer. This disengagement releases the slidable lid retainer so that it can be moved by the user on the base away from the lid pivot axis from the lid-motion-blocking position to the lid-motion-permitting position without disengaging the slidable lid retainer from the base to unlock the child-resistant case and to free the card-access lid so that it can be pivoted about the lid pivot axis by the user away from the slidable lid retainer to the opened position. Once the card-access lid is opened, the user can access the tablet-carrying blister cards located in the interior card-storage region formed in the base. The second lid lock is operated in the same manner and at the same time as the first lid lock to unlock the child-resistant case.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a blister-card package in accordance with the present disclosure suggesting that the package includes a closed and locked child-resistant case and a tablet-carrying blister card in the child-resistant case and showing that the child-resistant case comprises a pivotable card-access lid that is arranged to lie in a closed position on an underlying base to cover a lower portion of a tablet-carrying blister card located in an interior card-storage region formed in the base and showing that a slidable lid retainer also included in the child-resistant case is coupled to a far end of the base and arranged to lie in a lid-motion-blocking position engaging an adjacent free end of the pivotable card-access lid to cover an upper portion of the tablet-carrying blister card and to retain the lid in the closed position on the base and suggesting that separate first and second lid locks are included in the child-resistant case to lock the slidable lid retainer on the base in the lid-motion-blocking position to retain the lid in the closed position;

FIG. 2 is a perspective view similar to FIG. 1 showing that the closed child-resistant case has been unlocked in response to movement of the slidable lid retainer on the base to the left in a direction away from the pivotable card-access lid and its lid pivot axis to a lid-motion-permitting position to free the card-access lid to be pivoted upwardly in a clockwise direction about the lid pivot axis to the opened position shown in FIG. 3 after push actuation of the first and second lid locks mounted on opposite sides of the base as suggested diagrammatically in FIG. 1;

FIG. 3 is a perspective view similar to FIGS. 1 and 2 showing the card-access lid in the opened position to expose a tablet-carrying blister card located in the interior card-storage region formed in the base;

FIG. 4 is an exploded perspective assembly view of components included in the blister-card package of FIGS. 1-3 prior to assembly at a factory and showing that a tablet-carrying blister card can be coupled to two upright card-mounting posts included in the base and then located in the interior card-storage region formed in the base and that the slidable lid retainer can be mounted on the far end of the base and then moved, in sequence, on the base first to a lid-motion-permitting position shown in FIGS. 2 and 3 and then to a lid-motion-blocking position shown in FIG. 1;

FIG. 5 is an enlarged perspective view of a portion of the blister-card package of FIG. 4 before the slidable lid retainer has been slid onto the far (second) end of the base and after the blister card has been mounted on the card-mounting posts and placed in the interior card-storage region formed in the base and showing that first and second lid locks are included in the child-resistant case of the blister-card package;

FIG. 6 is an enlarged perspective view of a far portion of the blister-card package of FIG. 3, with portions broken away, showing the slidable lid retainer in the lid-motion-permitting position on the base;

FIGS. 7-9 show a sequence of mating a first keeper included in the first lid lock and coupled to the slidable lid retainer with a retainer-removal barrier included in the child-resistant case and coupled to the far (second) end of the base during mounting of the slidable lid retainer on the base at a factory so that the slidable lid retainer cannot later be separated easily from the base by a user in the field away from the factory;

FIG. 7 is an enlarged top plan view of a left-side portion of the package of FIG. 6 showing the first keeper coupled to the slidable lid retainer just before it contacts the retainer-removal barrier coupled to the base during movement of the slidable lid retainer on the base toward the lid pivot axis and also showing that the first lid lock also includes a spring-biased first latch including a cantilevered blocker-support arm and a motion blocker coupled to a free end of the cantilevered blocker-support arm;

FIG. 8 is a view similar to FIG. 7 showing engagement of an inwardly facing ramp included in the first keeper coupled to the slidable lid retainer with an outwardly facing ramp included in the retainer-removal barrier coupled to the base;

FIG. 9 is a view similar to FIGS. 7 and 8 showing movement of the first keeper coupled to the slidable lid retainer past the retainer-removal barrier coupled to the base to cause a flat stop face provided on the first keeper to mate with a flat stop face provided on the retainer-removal barrier to block removal of the slidable lid retainer from the base by a user in the field;

FIG. 10 is an enlarged perspective view of a portion of the blister-card package of FIG. 1, with portions broken away, showing the slidable lid retainer in the lid-motion-blocking position on the base;

FIGS. 11-13 show a sequence of mating the first keeper included in the first lid lock and coupled to the slidable lid retainer with a motion blocker included in the spring-biased first latch that is included in the first lid lock and coupled to the base to lock the slidable lid retainer to the base in the lid-motion-blocking position;

FIG. 11 is an enlarged top plan view of a left-side portion of the package of FIG. 10 showing the first keeper coupled to the slidable lid retainer just before it contacts the motion blocker coupled to the free end of the cantilevered blocker-support arm of the spring-biased first latch;

FIG. 12 is a view similar to FIG. 11 showing engagement of the inwardly facing ramp included in the first keeper coupled to the slidable lid retainer with an outwardly facing ramp included in the motion blocker; and

FIG. 13 is a view similar to FIGS. 11 and 12 showing movement of the first keeper coupled to the slidable lid retainer past the motion blocker to cause the flat stop face provided on the first keeper to mate with a flat stop face provided on the motion blocker to lock the slidable lid retainer to the base in the lid-motion-blocking position.

### DETAILED DESCRIPTION

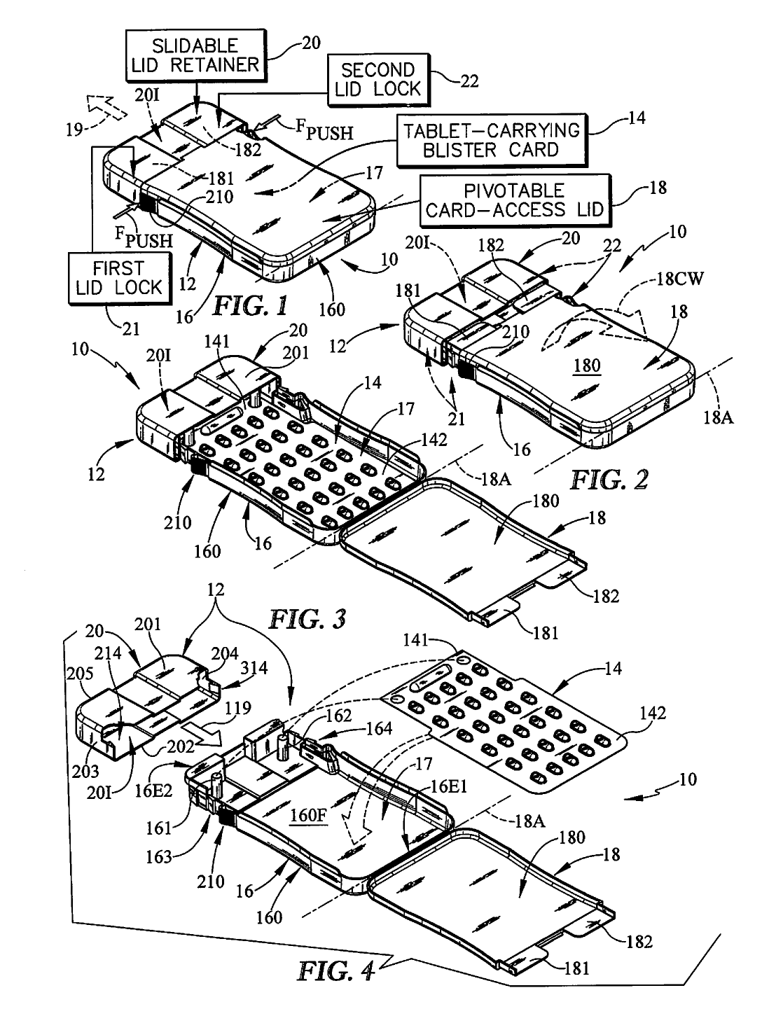

A blister-card package 10 includes a lockable child-restraint case 12 including a base 16 and a lid 18 as suggested in FIGS. 1-4. In illustrative embodiments, child-resistant case 12 is configured to hold one or more tablet-carrying blister cards 14 as suggested in FIGS. 1 and 3.

Child-resistant case 12 includes a base 16 formed to include an interior card-storage region 17 and a pivotable card-access lid 18 as shown best in FIG. 4. Child-resistant case 12 also includes a slidable lid retainer 20 that can be moved on base 16 when child-resistant case 12 is unlocked as shown in FIG. 2 without separating from base 16 to block or permit movement of the pivotable card-access lid 18 from the closed position shown in FIG. 2 to the opened position shown in FIG. 3. Sliding movement of slidable lid retainer 20 on base 16 is controlled by first and second lid locks 21, 22 coupled to child-resistant case 12.

Blister card 14 is accessed by applying inward push forces F_{PUSH} to the first and second lid locks 21, 22 included in child-resistant case 12 as suggested in FIG. 1 to unlock child-resistant case 12 so that a user can move slidable lid retainer 20 on base 16 formed in direction 19 relative to lid pivot axis 18A from a lid-motion-blocking position shown in FIG. 1 to a lid-motion-permitting position shown in FIG. 2 to permit the user to pivot the pivotable card-access lid 18 about lid pivot axis 18A in clockwise direction 18CW from the closed position shown in FIG. 2 to the opened position shown in FIG. 3. Once card-access lid 18 is opened, tablet-carrying blister cards 14 located in interior card-storage region 17 formed in base 16 are exposed as shown in FIG. 3 so that tablets 14T carried in blister cards 14 are available to the user.

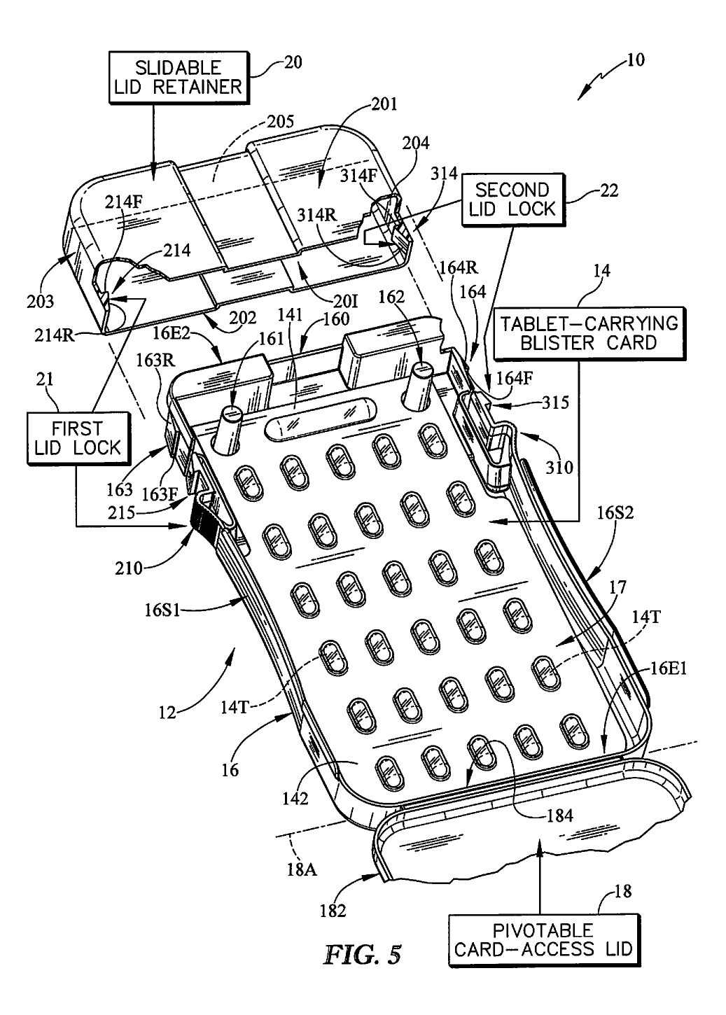

Base 16 of child-resistant case 12 is formed illustratively to include a blister-card container 160, an upstanding first card-mounting post 161, and an upstanding second card-mounting post 162 as shown, for example, in FIGS. 4 and 5. Blister-card container 160 is formed to include interior card-storage region 17 and a lower end of each of the posts 161, 162 is coupled to a floor 160F included in blister-card container 160 to locate posts 161, 162 in interior card-storage region 17 as shown, for example, in FIG. 4. As suggested in FIG. 5, base 16 has a first end 16E1 associated with pivotable card-access lid 18, a second end 16E2 associated with slidable lid retainer 20, a first side 16S1 associated with first lid lock 21, and a second side 16S2 associated with second lid lock 22.

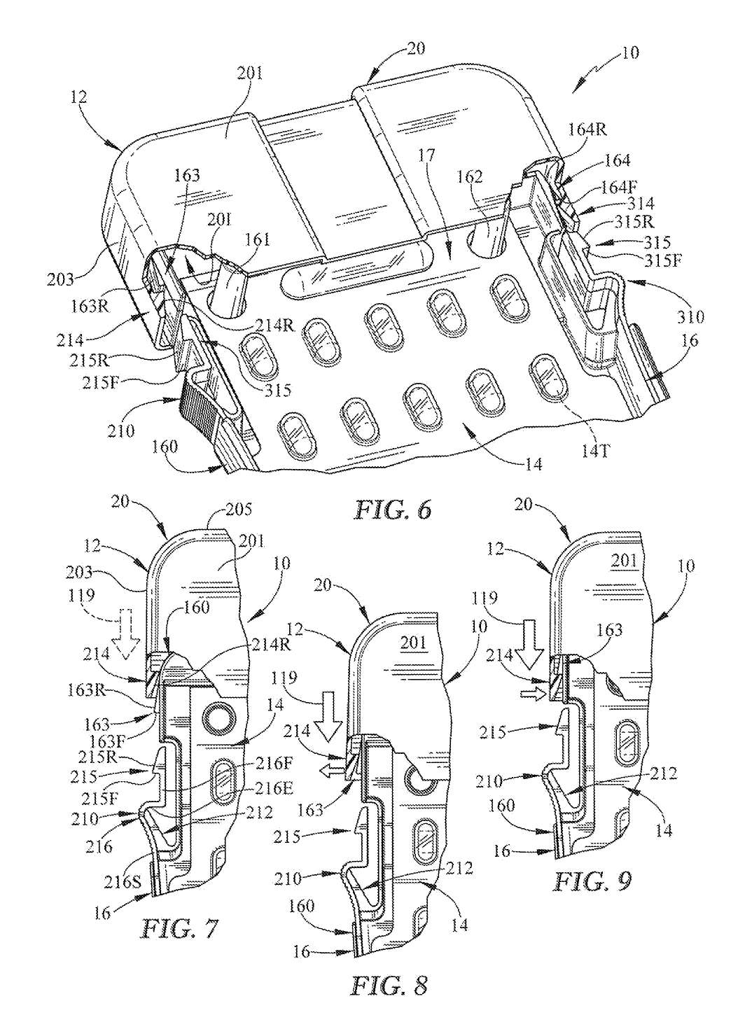

Base 16 also includes a first retainer-removal blocker 163 coupled to first side 16S1 of container 160 and a second retainer-removal blocker 164 coupled to second side 16S2 of container 160 as suggested in FIG. 5. These retainer-removal blockers 163, 164 are configured to interact with first and second keepers 214, 314 included in first and second lid locks 21, 22 to block removal of slidable lid retainer 20 from base 16 of child-resistant case 12 without inhibiting sliding movement of slidable lid retainer 20 on base 16 between the lid-motion-blocking position and the lid-motion-permitting position once the slidable lid retainer 20 has been mounted on second end 16E2 of base 16 at a factory. For example, such interaction between first retainer-removed blocker 163 and first keeper 214 is shown in FIGS. 7-10. First retainer-removal blocker 163 includes an outwardly facing ramp 163R and a rearwardly facing flat stop face 163F as shown in FIGS. 5 and 7. Second retainer-removal blocker 164 includes an outwardly facing ramp 164R and a rearwardly facing flat stop face 164F as shown in FIGS. 5 and 6.

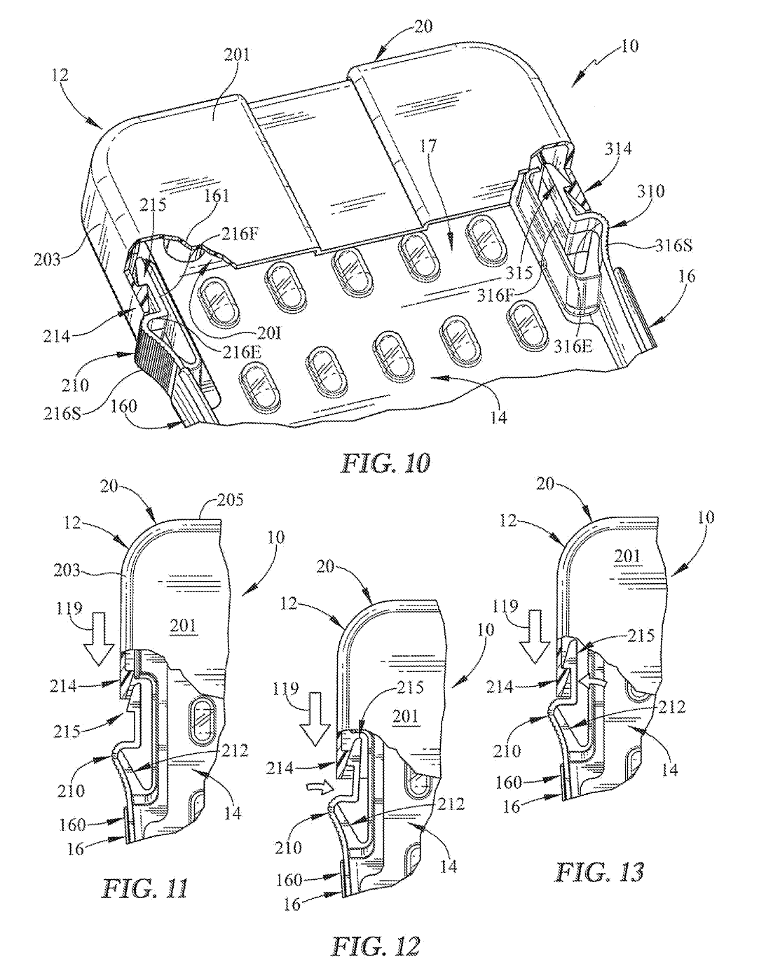

Pivotable card-access lid 18 includes a lid shell 180 that is coupled to blister-card container 160 at first end 16E1 of base 16 by a lid hinge 184 for pivotable movement about pivot axis 18A when child-resistant case 12 is unlocked as shown, for example, in FIGS. 4 and 5. Card-access lid 18 also includes first and second lid tabs 181, 182 cantilevered to a free end of lid shell 180 as shown in FIGS. 3 and 4. When card-access lid 18 is closed, a perimeter edge of lid shell 182 mates with a perimeter edge of blister-card container 160 as suggested in FIGS. 1-4. As long as the slidable lid retainer 20 is moved on base 16 to assume the lid-motion-blocking position shown in FIGS. 1 and 10 in which first and second lid tabs 181, 182 are trapped in an interior region 201 formed in slidable lid retainer 20, then pivoting movement of pivotable card-access lid 18 about lid pivot axis 18A in clockwise direction 18CW will be blocked. Only when slidable lid retainer 20 is moved in direction 19 away from lid pivot axis 18A to the lid-motion-permitting position shown in FIG. 2 are the lid tabs 181, 182 withdrawn from interior region 201 of slidable lid retainer 20 and exposed to free pivotable card-access lid 18 to be pivoted by a user about lid pivot axis 18A in clockwise direction 18CW from the closed position shown in FIG. 2 to the opened position shown in FIG. 3.

Slidable lid retainer 20 includes a top wall 201, bottom wall 202, first side wall 203, second side wall 204, and an end wall 205 as suggested in FIG. 5. End wall 205 is coupled to rear portions of each of the other walls 201-204 and cooperates with walls 201-204 to form interior region 201. As suggested in FIG. 5, a portion (e.g., first keeper 214) of first lid lock 21 is coupled to an inwardly facing surface of first side wall 203 of slidable lid retainer 20 and another portion (e.g., spring-biased first latch 210) of first lid lock 21 is coupled to first side wall 16S1 of blister-card container 160. As also suggested in FIG. 5, a portion (e.g., second keeper 314) of second lid lock 22 is coupled to an inwardly facing surface of second side wall 204 of slidable lid retainer 20 and another portion (e.g., spring-biased second latch 310) of second lid lock 22 is coupled to second side wall 1652 of blister-card container 160.

First lid lock 21 of child-resistant case 12 is associated with base 16 and slidable lid retainer 20 as suggested in FIG. 5 and configured to lock slidable lid retainer 20 in a stationary position on base 16 as suggested in FIGS. 1, 10, and 13. First lid lock 21 includes a spring-biased first latch 210 cantilevered to first side wall 16S1 of blister-card container 160, an elastic latch-return spring 212 coupled to first latch 210 and to container 160, and a first keeper 214 coupled to an inwardly facing surface of first side wall 203 of slidable lid retainer 20. First latch 210 is urged by spring 212 to engage first keeper 214 when slidable lid retainer 20 has been moved to the lid-motion-blocking position so that the pivotable card-access lid 18 is retained in the closed position on base 16.

The spring-biased first latch 210 includes a motion blocker 215 and a blocker-support arm 216 cantilevered at one end to blister-card container 160 and coupled at an opposite end to motion blocker 214 as shown, for example, in FIG. 7. Motion blocker 215 includes an outwardly facing ramp 215R and rearwardly facing flat stop face 215F. Blocker-support arm 216 includes, in series, a shoulder 216S formed to include a finger pad, an elbow 216E, and a forearm 216F coupled to motion blocker 215 as suggested in FIGS. 7 and 10.

First keeper 214 of first lid lock 21 includes an inwardly facing ramp 214R and a forwardly facing flat stop face 214F as shown in FIGS. 5 and 7. Ramp 214R of first keeper 214 is inclined to ride in camming relation first on ramp 163R of retainer-removal blocker 163 as first keeper 214 is moved past retainer-removal blocker 163 as suggested in FIGS. 5-7 and then on ramp 215R of motion blocker 215 as first keeper 214 is moved past motion blocker 215 when slidable lid retainer 20 is moved on base 16 in direction 119 toward lid pivot axis 18A and the lid-motion-blocking position as shown in FIGS. 11-13.

Second lid lock 22 of child-resistant case 12 is associated with base 16 and slidable lid retainer 20 as suggested in FIG. 5 and configured to lock lid retainer 20 in a stationary position on base 16 as suggested in FIG. 1. Second lid lock 22 includes a spring-biased second latch 310 cantilevered to second side wall 16S2 of blister-card container 160, an elastic latch-return spring 312 coupled to second latch 310 and to container 160, and a second keeper 314 coupled to an inwardly facing surface of second side wall 204 of lid retainer 20. Second latch 310 is urged by spring 312 to engage second keeper 314 when slidable lid retainer 20 has been moved to the lid-blocking position so that the pivotable card-access lid 18 is retained in the closed position on base 16.

The second spring-biased second latch 310 includes a motion blocker 315 and a blocker-support arm 316 cantilevered at one end to blister-card container 160 and coupled at an opposite end to motion blocker 314 as shown, for example, in FIG. 6. Motion blocker 315 includes an outwardly facing ramp 315R and rearwardly facing flat stop face 315F as suggested in FIG. 6. Blocker-support arm 316 is similar in shape to blocker-support arm 216 and includes, in series, a shoulder 316S formed to include a finger pad, an elbow 316E, and a forearm 316F coupled to motion blocker 315 as suggested in FIG. 10.

Second keeper 314 of second lid lock 22 includes an inwardly facing ramp 314R and a forwardly facing flat stop face 314F as shown in FIG. 5. Ramp 314R of second keeper 314 is inclined to ride in camming relation first on ramp 164R of retainer-removal blocker 164 as second keeper 314 is moved past retainer-removal blocker 164 and then on ramp 315R of motion blocker 315 as second keeper 314 is moved past motion blocker 315 when slidable lid retainer 20 is moved on base 16 in direction 119 toward lid pivot axis 18A and the lid-motion-blocking position.

A package 10 includes a child-resistant case 12 and a set of tablet-carrying blister cards 14 as suggested in FIGS. 1-4. Child-resistant case 12 includes a base 16 formed to include an interior card-storage region 17, a pivotable card-access lid 18 including a lid shell 180 coupled to a first end of the base 16 for pivotable movement about a lid pivot axis 18A by a lid hinge 184 and a slidable lid retainer 20 mounted for slidable movement on an opposite second end of the base 16 relative to the lid pivot axis 18A from a lid-motion-blocking position engaging the pivotable card-access lid 18 in a direction away from the lid pivot axis 18A to a lid-motion-releasing position disengaging the pivotable card-access lid 18 to control pivoting of the lid 18 relative to the base 16 from a closed position on the base 16 to an opened position away from the base 16. The set of tablet-carrying blister cards 14 is located in the interior card-storage region 17 of the base 16 to be accessed only when the slidable lid retainer 20 occupies the lid-motion-releasing position and the lid 18 occupies the opened position.

A first portion 141 of the set of tablet-carrying blister cards 14 is arranged to extend toward the opposite second end 16E2 of the base 16 and lie between a floor 160F of the base 16 and a top wall 201 of the slidable lid retainer 20 when the slidable lid retainer 20 occupies the lid-motion-blocking position as suggested in FIGS. 1-4. A second portion 142 of the set of tablet-carrying blister cards 14 is arranged to extend toward the first end of the base 16 and lie between the floor 160F of the base 16 and the lid shell 180 when the pivotable card-access lid 18 occupies the closed position as also suggested in FIGS. 1-4.

The pivotable card-access lid 18 further includes a first lid tab 181 coupled to a free end of the lid shell 180 and arranged to extend away from the lid pivot axis 18A to lie in a space provided between the first portion 141 of the set of tablet-carrying blister cards 14 and the top wall 201 of the slidable lid retainer 20 when the pivotable card-access lid 18 occupies the closed position and the slidable lid retainer 20 occupies the lid-motion blocking-position as suggested in FIGS. 1-4. First lid tab 181 is arranged to lie above the first portion 141 of the set of tablet-carrying blister cards 14 when the pivotable card-access lid 18 occupies the closed position and to lie in a space provided between the slidable lid retainer 20 and the lid shell 180 when the slidable lid retainer 20 occupies the lid-motion-releasing position to free the first lid tab 181 and the lid shell 180 to move away from the set of tablet-carrying blister cards 14 during pivotable movement of the pivotable card-access lid 18 about the lid pivot axis 18A from the closed position to the opened position as suggested in FIGS. 1-4.

An exploded perspective assembly view of components included in the blister-card package of FIGS. 1-3 prior to assembly at a factory is provided in FIG. 4. This view suggests that a tablet-carrying blister card 14 can be coupled to two upright card-mounting posts 161, 162 included in base 16 and then located in interior card-storage region 17 formed in base 16. Slidable lid retainer 20 then can be mounted on the far end 16E2 of base 16 and then moved, in sequence, on base 16 first to a lid-motion-permitting position shown in FIGS. 2 and 3 and then to a lid-motion-blocking position shown in FIG. 1.

A sequence is shown in FIGS. 7-9 of mating a first keeper 214 included in first lid lock 21 and coupled to slidable lid retainer 20 with a retainer-removal barrier 163 included in the child-resistant case 12 and coupled to container 160 of base 16 during mounting of slidable lid retainer 20 on base 16 at a factory so that slidable lid retainer 20 cannot later be separated easily from base 16 by a user in the field away from the factory. First keeper 214 is shown in FIG. 7 to be coupled to slidable lid retainer 20 just before it contacts the retainer-removal barrier 163 coupled to container 160 during movement of slidable lid retainer 20 on base 16. First lid lock 21 also includes a spring-biased first latch 210 including a cantilevered blocker-support arm 216 and a motion blocker 215 coupled to a free end of cantilevered blocker-support arm 216. An inwardly facing ramp 214R included in first keeper 214 that is coupled to the slidable lid retainer 20 is engaged as shown in FIG. 8 with an outwardly facing ramp 163R included in the retainer-removal barrier 163 coupled to container 160 of base 16.

Then, as suggested in FIG. 9, the first keeper 214 that is coupled to slidable lid retainer 20 is moved past the retainer-removal barrier 163 coupled to container 160 to cause a flat stop face 214F provided on first keeper 214 to mate with a flat stop face 163F provided on the retainer-removal barrier 163 to block removal of slidable lid retainer 20 from base 16 by a user in the field. An enlarged perspective view of a portion of blister-card package 10 of FIG. 1, with portions broken away, is provided in FIG. 10 to show the slidable lid retainer 20 in the lid-motion-blocking position on base 16.

A sequence is shown in FIGS. 11-13 of mating first keeper 214 included in first lid lock 21 and coupled to slidable lid retainer 20 with a motion blocker 215 included in the spring-biased first latch 210 that is included in the first lid lock 21 and coupled to base 16 to lock the slidable lid retainer 20 to base 16 in the lid-motion-blocking position. The first keeper 214 that is coupled to slidable lid retainer 20 is shown in FIG. 11 just before it contacts the motion blocker 215 coupled to the free end of the cantilevered blocker-support arm 216 of spring-biased first latch 210. The inwardly facing ramp 214R included in the first keeper 214 that is coupled to the slidable lid retainer 20 is engaged as shown in FIG. 12 with an outwardly facing ramp 215R included in the motion blocker 215. FIG. 13 is a view similar to FIGS. 11 and 12 showing movement of the first keeper 214 coupled to slidable lid retainer 20 past motion blocker 215 to cause the flat stop face 214F provided on the keeper 214 to mate with a flat stop face 215F provided on the motion blocker 215 to lock slidable lid retainer 20 to base 16 in the lid-motion-blocking position.

To actuate first lid lock 21 in accordance with the present disclosure, a user manually applies a push force (F_{PUSH}) to push the spring-biased first latch 210 inwardly toward the blister cards 14 located in interior card-storage region 17 of base 16 to cause first latch 210 to disengage the first keeper 214 coupled to the slidable lid retainer 20. This disengagement releases slidable lid retainer 20 so that it can be moved by the user on base 16 away from the pivot axis 18A from the lid-motion-blocking position to the lid-motion-permitting position to unlock the child-resistant case 12 and to free card-access lid 18 so that it can be pivoted about the pivot axis 18A by the user to the opened position. Once card-access lid 18 is opened, the user can access the tablet-carrying blister cards 14 located in interior card-storage region 17 formed in base 16. Second lid lock 22 is operated in the same manner and at the same time as first lid lock 21 to unlock the child-resistant case 12.

1. A child-resistant case comprising
a base formed to include an interior article-storage region,
a lid coupled to a first end of the base for pivotable movement about a lid pivot axis from a closed position on the base to an opened position away from the base, and
a slidable lid retainer mounted for sliding movement on an opposite second end of the base without separation from the base from a lid-motion-blocking position arranged to engage a free end of the lid to block pivotable movement of the lid about the lid pivot axis from the closed position to the opened position and a lid-motion-permitting position arranged to release the free end of the lid so that the lid can be pivoted by a user about the lid pivot axis from the closed position to the opened position to allow the user to access articles stored in the interior article-storage region formed in the base.

2. The child-resistant case of claim 1, wherein the lid includes a lid shell and a hinge coupled to the lid shell and to the first end of the base to support the lid shell for pivotable movement relative to the base about the lid pivot axis and the lid shell and the slidable lid retainer cooperate to form a closure covering a top access port opening into the interior article-storage region formed in the base when the lid occupies the closed position and the slidable lid retainer occupies the lid-blocking position.

3. The child-resistant case of claim 2, further comprising a first lid lock associated with the base and the slidable lid retainer and configured to lock the slidable lid retainer in a stationary position on the base upon arrival of the slidable lid retainer at the lid-blocking position and wherein the first lid lock includes a first keeper coupled to the slidable lid retainer to move therewith, a first latch coupled to the base, and an elastic latch-return spring arranged to yieldably urge the first latch to engage the first keeper when the slidable lid retainer has been moved on the base to assume the closed position, and wherein the first keeper is arranged to separate from the first latch during movement of the first latch toward the base to load the elastic latch-return spring to free the slidable lid retainer to slide on the second end of the base in a first direction away from the lid pivot axis and the first keeper is arranged to engage a first retainer-removal blocker included in the base and located outside the interior article-storage region to block further sliding movement of the slidable lid retainer on the base in the first direction away from the lid pivot axis.

4. The child-resistant case of claim 3, wherein the base includes a container formed to include the interior article-storage region, the base further includes a first retainer-removed blocker coupled to the container to lie outside of the interior article-storage region, the first latch of the first lid lock is cantilevered to a first side wall of the container to lie outside of the interior article-storage region, and the elastic latch-return spring is coupled to the first latch and to the container to cause the first latch to be urged by the elastic latch-return spring to engage the first keeper when the slidable lid retainer occupies the lid-motion-blocking position so that the lid is retained in the closed position on the base.

5. The child-resistant case of claim 4, wherein the first latch includes a motion blocker and a blocker-support arm cantilevered at one end to the container and coupled at an opposite end to the motion blocker, the motion blocker includes an outwardly facing ramp and a rearwardly facing flat step face facing toward the lid pivot axis, the first keeper includes an inwardly facing ramp facing toward the interior article-storage region formed in the container and a forwardly facing flat stop face facing away from the lid pivot axis, and the rearwardly facing flat stop face of the motion blocker mates with the forwardly facing flat stop face of the first keeper upon arrival of the slidable lid retainer at the lid-motion-blocking position on the base to retain the lid in the closed position.

6. The child-resistant case of claim 5, wherein the inwardly facing ramp of the first keeper is inclined to ride in camming relation first on a ramp included in the retainer-removal blocker as the first keeper is moved past the retainer-removal blocker in a direction toward the lid pivot axis as the slidable lid retainer is moved on the base from the lid-motion-releasing position toward the lid-motion-blocking position and then on the outwardly facing ramp of the motion blocker as the first keeper is moved past the motion blocker of the first latch.

7. The child-resistant case of claim 5, wherein the inwardly-facing ramp included in the first keeper is engaged in camming relation to an outwardly facing ramp included in the retainer-removal barrier during sliding movement of the slidable lid retainer on the second end of the base from the lid-motion-releasing position toward the lid-motion-blocking position.

8. The child-resistant case of claim 5, wherein the flat stop face provided on the first keeper is arranged to mate with a flat stop face provided on the retainer-removal barrier when the lid occupies the lid-motion-releasing position to block removal of the slidable lid retainer from the second end of the base by a user in the field.

9. The child-resistant case of claim 2, wherein the lid further includes a first lid tab coupled to a free end of the lid shell and arranged to extend away from the lid pivot axis to lie trapped in a space provided between the base and a top wall of the slidable lid retainer when the slidable lid retainer occupies the lid-motion-blocking position to block pivotable movement of the lid from the closed position to the opened position and wherein the top wall of the slidable lid retainer is separated from the first lid tab to locate the first lid tab in an exposed position between the first side wall of the slidable lid retainer and the lid shell to free the lid to pivot relative to the base from the closed position to the opened position without causing the first lid tab to engage the top wall of the slidable lid retainer.

10. The child-resistant case of claim 9, wherein the base includes a container formed to include the interior article-storage region and a first retainer-removal blocker coupled to the container to lie outside of the interior article-storage region and further comprising a first keeper coupled to the slidable lid retainer to move therewith and arranged to engage the first retainer-removal blocker to block removal of the slidable lid retainer from the base and to cause the slidable lid retainer to remain engaged to the second end of the base to locate the first lid tab in the exposed position after the slidable lid retainer has been moved on the base to assume the lid-motion-permitting position.

11. The child-resistant case of claim 9, further comprising a first lid lock associated with the base and the slidable lid retainer and configured to lock the slidable lid retainer in a stationary position on the base upon arrival of the slidable lid retainer at the lid-blocking position and wherein the first lid lock includes a first keeper coupled to the slidable lid retainer to move therewith, a first latch coupled to the base, and an elastic latch-return spring arranged to yieldably urge the first latch to engage the first keeper when the slidable lid retainer has been moved on the base to assume the closed position, and wherein the first keeper is arranged to separate from the first latch during movement of the first latch toward the base to load the elastic latch-return spring to free the slidable lid retainer to slide on the second end of the base in a first direction away from the lid pivot axis and the first keeper is arranged to engage a first retainer-removal blocker included in the base and located outside the interior article-storage region to block further sliding movement of the slidable lid retainer on the base in the first direction away from the lid pivot axis.

12. The child-resistant case of claim 9, further comprising a first lid lock associated with the slidable lid retainer and a first side of the base and configured to lock the slidable lid retainer in a stationary position on the base upon arrival of the slidable lid retainer at the lid-blocking position and a second lid lock associated with the slidable lid retainer and an opposite second side of the base and configured to lock the slidable lid retainer in the stationary position on the base upon arrival of the slidable lid retainer at the lid-blocking position and wherein the first lid tab included in the lid is arranged to lie between the first and second lid locks when the lid occupies the closed position.

13. The child-resistant case of claim 9, wherein the slidable lid retainer further includes a bottom wall arranged to underlie the base and lie in spaced-apart relation to the top wall to locate the second end of the base therebetween, a first side wall arranged to interconnect first outer edges of the bottom and top walls, and a second side wall arranged to interconnect second outer edges of the bottom and top walls and arranged to lie in spaced-apart relation to one another to locate the second end of the base therebetween and to cooperate with the top, bottom, and first side walls to form an interior region receiving the second end of the base, the base includes a first retainer-removal blocker and a container formed to include the interior article-storage region, and the first retainer-removal blocker is coupled to the container to lie outside of the interior article-storage region formed in the container and inside the interior region formed in the slidable lid retainer, and further comprising a first keeper coupled to the first side wall of the slidable lid retainer to move therewith and arranged to lie in the interior region of the slidable lid retainer to lie in a space provided between the container and the first side wall of the slidable lid retainer, and wherein the first keeper is arranged to engage the first retainer-removal blocker to block removal of the slidable lid retainer from the base and to cause the slidable lid retainer to remain engaged to the second end of the base to locate the first lid tab in the exposed position after the slidable lid retainer has been moved on the base to assume the lid-motion-permitting position.

14. The child-resistant case of claim 1, wherein wherein the slidable lid retainer further includes a bottom wall arranged to underlie the base and lie in spaced-apart relation to the top wall to locate the second end of the base therebetween, a first side wall arranged to interconnect first outer edges of the bottom and top walls, and a second side wall arranged to interconnect second outer edges of the bottom and top walls and arranged to lie in spaced-apart relation to one another to locate the second end of the base therebetween and to cooperate with the top, bottom, and first side walls to form an interior region receiving the second end of the base, the base includes a first retainer-removal blocker and a container formed to include the interior article-storage region, and the first retainer-removal blocker is coupled to the container to lie outside of the interior article-storage region formed in the container and inside the interior region formed in the slidable lid retainer, and further comprising a first keeper coupled to the first side wall of the slidable lid retainer to move therewith and arranged to lie in the interior region of the slidable lid retainer to lie in a space provided between the container and the first side wall of the slidable lid retainer, and wherein the first keeper is arranged to engage the first retainer-removal blocker to block removal of the slidable lid retainer from the base and to cause the slidable lid retainer to remain engaged to the second end of the base.

15. The child-resistant case of claim 14, wherein the first keeper includes an inwardly facing ramp facing toward the interior article-storage region formed in the container and a forwardly facing flat stop face facing away from the lid pivot axis and the inwardly facing ramp of the first keeper is inclined to ride in camming relation on an outwardly facing ramp included in the retainer-removal blocker and arranged to face away from the interior article-storage region formed in the container as the first keeper is moved past the retainer-removal blocker in a direction toward the lid pivot axis as the slidable lid retainer is moved on the base from the lid-motion-releasing position toward the lid-motion-blocking position.

16. The child-resistant case of claim 15, wherein the flat stop face provided on the first keeper is arranged to mate with a flat stop face provided on the retainer-removal barrier when the lid occupies the lid-motion-releasing position to block removal of the slidable lid retainer from the second end of the base by a user in the field.

17. A package comprising
a child-resistant case including a base formed to include an interior card-storage region, a pivotable card-access lid including a lid shell coupled to a first end of the base for pivotable movement about a lid pivot axis by a lid hinge, and a slidable lid retainer mounted for slidable movement on an opposite second end of the base relative to the lid pivot axis from a lid-motion-blocking position engaging the pivotable card-access lid in a direction away from the lid pivot axis to a lid-motion-releasing position disengaging the pivotable card-access lid to control pivoting of the pivotable card-access lid relative to the base from a closed position on the base to an opened position away from the base, and
a set of tablet-carrying blister cards located in the interior card-storage region of the base to be accessed only when the slidable lid retainer occupies the lid-motion-releasing position and the pivotable card-access lid occupies the opened position.

18. The package of claim 17, wherein a first portion of the set of tablet-carrying blister cards is arranged to extend toward the opposite second end of the base and lie between a floor of the base and a top wall of the slidable lid retainer when the slidable lid retainer occupies the lid-motion-blocking position and a second portion of the set of tablet-carrying blister cards is arranged to extend toward the first end of the base and lie between the floor of the base and the lid shell when the pivotable card-access lid occupies the closed position.

19. The package of claim 18, wherein the pivotable card-access lid further includes a first lid tab coupled to a free end of the lid shell and arranged to extend away from the lid pivot axis to lie in a space provided between the first portion of the set of tablet-carrying blister cards and the top wall of the slidable lid retainer when the pivotable card-access lid occupies the closed position and the slidable lid retainer occupies the lid-motion-blocking position.

20. The package of claim 18, wherein the pivotable card-access lid further includes a first lid tab coupled to a free end of the lid shell and arranged to extend away from the lid pivot axis to lie above the first portion of the set of tablet-carrying blister cards when the pivotable card-access lid occupies the closed position and to lie in a space provided between the slidable lid retainer and the lid shell when the slidable lid retainer occupies the lid-motion-releasing position to free the first lid tab and the lid shell to move away from the set of tablet-carrying blister cards during pivotable movement of the pivotable card-access lid about the lid pivot axis from the closed position to the opened position.
